(19) United States
(12) Patent Application Publication
(10) Pub. No.: US 2024/0389135 A1
(43) Pub. Date: Nov. 21, 2024

(54) RANDOM ACCESS TO SECONDARY CELL

(71) Applicant: Nokia Technologies Oy, Espoo (FI)

(72) Inventors: Chunli WU, Beijing (CN); Samuli Heikki TURTINEN, Oulu (FI); Lei DU, Beijing (CN)

(21) Appl. No.: 18/691,776

(22) PCT Filed: Oct. 21, 2021
(86) PCT No.: PCT/CN2021/125426

§ 371 Date: Mar. 13, 2024

(51) Int. Cl. H04W 74/00; H04W 48/20; H04W 74/0833

(52) U.S. Cl. CPC H04W 74/004; H04W 48/20; H04W 74/0833

(57) ABSTRACT

Example embodiments of the present disclosure relate to random access to a secondary cell (SCell). A first device receives, from a second device, configuration information indicating first resources for the first device to perform a random access to a secondary cell of the first device. Radio network temporary identifiers corresponding to the first resources are different from radio network temporary identifiers corresponding to second resources configured for a random access to a primary cell of the first device. The first device selects a resource from the first resources and transmits, to the second device via the secondary cell, a random access request by using the selected resource.

### FIELD

Embodiments of the present disclosure generally relate to the field of telecommunication and in particular, to a device, method, apparatus and computer readable storage medium for random access to a secondary cell (SCell).

### BACKGROUND

A random access (RA) procedure refers to a procedure for a terminal device to establish or reestablish a connection with a network device such as an Evolved NodeB (eNB) or a 5G gNodeB (gNB). A contention based random access (CBRA) procedure can facilitate the possibility that multiple communication devices may be interested in attempting to access the network device through the RA procedure at the same or similar point in time. Once access has been established and/or confirmed, the network device can assign resources to a particular terminal device for uplink and downlink communication with the network device.

### SUMMARY

In general, example embodiments of the present disclosure provide a solution for random access to a SCell. Embodiments that do not fall under the scope of the claims, if any, are to be interpreted as examples useful for understanding various embodiments of the disclosure.

In a first aspect, there is provided a first device. The first device comprises at least one processor; and at least one memory including computer program code; where the at least one memory and the computer program code are configured to, with the at least one processor, cause the first device to receive, from a second device, configuration information indicating first resources for the first device to perform a random access to a secondary cell of the first device, wherein radio network temporary identifiers corresponding to the first resources are different from radio network temporary identifiers corresponding to second resources configured for a random access to a primary cell of the first device; select a resource from the first resources; and transmit, to the second device via the secondary cell, a random access request by using the selected resource.

In a second aspect, there is provided a second device. The second device comprises at least one processor; and at least one memory including computer program code; where the at least one memory and the computer program code are configured to, with the at least one processor, cause the second device to allocate first resources for a first device to perform a random access to a secondary cell of the first device, wherein radio network temporary identifiers corresponding to the first resources are different from radio network temporary identifiers corresponding to second resources configured for a random access to a primary cell of the first device; transmit, to the first device, configuration information indicating the first resources; and receive, via the secondary cell, a random access request by using a resource from the first resources.

In a third aspect, there is provided a method. The method comprises receiving, at a first device and from a second device, configuration information indicating first resources for the first device to perform a random access to a secondary cell of the first device, wherein radio network temporary identifiers corresponding to the first resources are different from radio network temporary identifiers corresponding to second resources configured for a random access to a primary cell of the first device; selecting a resource from the first resources; and transmitting, to the second device via the secondary cell, a random access request by using the selected resource.

In a fourth aspect, there is provided a method. The method comprises allocating, at a second device, first resources for a first device to perform a random access to a secondary cell of the first device, wherein radio network temporary identifiers corresponding to the first resources are different from radio network temporary identifiers corresponding to second resources configured for a random access to a primary cell of the first device; transmitting, to the first device, configuration information indicating the first resources; and receiving, via the secondary cell, a random access request by using a resource from the first resources.

In a fifth aspect, there is provided a first apparatus. The first apparatus comprises means for receiving, from a second apparatus, configuration information indicating first resources for the first apparatus to perform a random access to a secondary cell of the first apparatus, wherein radio network temporary identifiers corresponding to the first resources are different from radio network temporary identifiers corresponding to second resources configured for a random access to a primary cell of the first apparatus; means for selecting a resource from the first resources; and means for transmitting, to the second apparatus via the secondary cell, a random access request by using the selected resource.

In a sixth aspect, there is provided a second apparatus. The second apparatus comprises means for allocating first resources for a first apparatus to perform a random access to a secondary cell of the first apparatus, wherein radio network temporary identifiers corresponding to the first resources are different from radio network temporary identifiers corresponding to second resources configured for a random access to a primary cell of the first apparatus; means for transmitting, to the first apparatus, configuration information indicating the first resources; and means for receiving, via the secondary cell, a random access request by using a resource from the first resources.

In a seventh aspect, there is provided a computer readable medium. The computer readable medium comprises program instructions for causing an apparatus to perform at least the method according to the third aspect, or fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart showing an example process of RA to a SCell according to some example embodiments of the present disclosure;

FIG. 3 illustrates a signaling chart showing another example process of RA to a SCell according to some example embodiments of the present disclosure;

FIG. 4 illustrates a flowchart of a method implemented at a first device according to some example embodiments of the present disclosure;

FIG. 5 illustrates a flowchart of a method implemented at a second device according to some example embodiments of the present disclosure;

FIG. 6 illustrates a flowchart of another method implemented at a first device according to some example embodiments of the present disclosure;

FIG. 7 illustrates a flowchart of another method implemented at a second device according to some example embodiments of the present disclosure;

FIG. 8 illustrates a simplified block diagram of a device that is suitable for implementing example embodiments of the present disclosure; and

FIG. 9 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU), and a Distributed Unit (DU). An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “RA resource” refers to a resource for performing random access. An RA resource may be used for transmission of random access request and may include a time-frequency domain resource and one or more random access preambles. The time-frequency domain resource is also referred to as a random access occasion (RO).

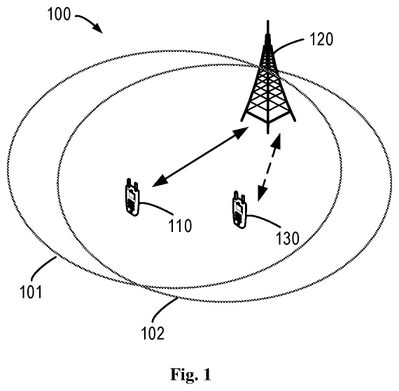

FIG. 1 shows an example communication environment 100 in which example embodiments of the present disclosure can be implemented. In the communication environment 100, a plurality of communication devices, including a first device 110 and a second device 120 can communicate with each other. In the example of FIG. 1, the first device 110 is illustrated as a terminal device, while the second device 120 is illustrated as a network device serving the terminal device.

The second device 120 may provide one or more serving cells to serve the first device 110. Carrier aggregation (CA) may be supported in the environment 100, in which two or more component carriers (CCs) are aggregated in order to support a broader bandwidth. In CA, the second device 120 may provide to the first device 110 a plurality of serving cells including a primary cell (PCell) 101 and at least one at least one secondary cell (SCell) 102. Although only one SCell 102 is shown in FIG. 1, the second device 120 may provide a plurality of SCells to the first device 110.

In some example embodiments, the environment 100 may further comprise a third device 130 which can communicate with the second device 120. The second device 120 may provide to the third device 130 one or more serving cells. In some example embodiments, the SCell 102 which serves the first device 110 as a secondary cell may serve the third device 130 as a primary cell. Alternatively, the third device 120 may be able to camp on the SCell 102.

It is to be understood that the number of devices and their connections shown in FIG. 1 are only for the purpose of illustration without suggesting any limitation. The environment 100 may include any suitable number of network devices, terminal devices and serving cells adapted for implementing embodiments of the present disclosure. It is to be noted that the term “cell” and “serving cell” can be used interchangeably herein. It is noted that although illustrated as a network device, the second device 120 may be other device than a network device. Although illustrated as a terminal device, the first device 110 may be other device than a terminal device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Through an RA procedure, the first device 110 can establish or reestablish a connection with the second device 120. In some scenarios, the first device 110 may need to perform an RA to the SCell 102. For example, the SCell 102 may be configured as a physical uplink control channel (PUCCH) SCell. In a PUCCH SCell activation procedure, the first device 110 needs to perform an RA to the SCell 102 to get a valid timing advance (TA).

Conventionally, only contention free random access (CFRA) is supported for SCell. CFRA to SCell can only be initiated by the gNB to establish timing advance for a secondary timing advance group (TAG). Specifically, the procedure is initiated by the gNB with a physical downlink control channel (PDCCH) order that is sent on a scheduling cell of an activated SCell of the secondary TAG, preamble transmission takes place on the indicated SCell, and Random Access Response (RAR) takes place on PCell.

In the case of PUCCH SCell activation, the gNB needs to activate the PUCCH SCell. Since PUCCH is configured on the PUCCH SCell itself, the UE is unable to report beam information before it gets a valid TA. Accordingly, the gNB does not have beam information to be indicated in the PDCCH order for CFRA to the PUCCH SCell. The UE cannot perform the CFRA to the PUCCH SCell.

To enable the CFRA to the PUCCH SCell without TA, the UE needs to report beam information via other cells which is currently not supported. An alternative solution may be CBRA to the PUCCH SCell which is not supported neither, since the UE is not monitoring Common Search Space (CSS) of SCell and the RAR for SCell is sent via PCell. At the same time, the SCell timing/TA can be acquired.

If the RAR remains being sent via PCell without requiring the UE to monitor the CSS of SCell, there may be some issues for CBRA to SCell. From gNB point of view, the gNB is not able to distinguish whether the preamble from the SCell is either from a UE camp on that cell/with that cell configured as PCell or from a UE with PUCCH SCell currently being activated. From UE point of view, upon reception of the RAR via PCell, the UE is not able to distinguish whether the RAR is a response for RA to SCell or for RA to PCell by some other UE(s), which might cause unintended MSG3 transmission to the wrong cell. Even with an introduction of an explicit indication in the RAR whether the RAR is a response for RA to SCell or RA to PCell, it would not work since legacy UEs are unable to recognize the indication and would falsely transmit MSG3 on unallocated resources over PCell in case the RAR was meant for SCell. How to solve the above issues for CBRA to SCell has not been detailed.

According to example embodiments of the present disclosure, there is provided a solution for RA to SCell. In some example embodiments, separate RA resources are configured for a first device to perform the RA to SCell. The separate RA resources are different from common resources in system information broadcast for the SCell by the network. That is, such common resources can be used by devices (for example, UEs) camping on the SCell which means it would be a PCell for such devices. In other words, the separate resources are different from the RA resources configured for another device which is able to camp on the SCell or for which the SCell acts as a PCell. In some example embodiments, RA resources are partitioned between PCell and SCell such that the PCell and SCell of the first device are not configured with RA resources corresponding to same radio network temporary identifier (RNTI) or Random Access RNTI (RA-RNTI). In some example embodiments, the first device monitors a CSS of the SCell and receives the RAR from the second device via the SCell.

Through this solution, CBRA to SCell is enabled to solve the issue of the network not knowing beam information when activating an unknown PUCCH SCell without valid TA since the preamble used for the RA procedure indicates to the second device (for example, the network device) the first device (for example, UE) preferred downlink beam. However, it is to be understood that the example embodiments of the present disclosure is not limited to CBRA to PUCCH SCell. Rather, the example embodiments of the present disclosure are applicable to any RA to SCell including CFRA to SCell.

Example embodiments of the present disclosure will be described in detail below with reference to the accompanying drawings.

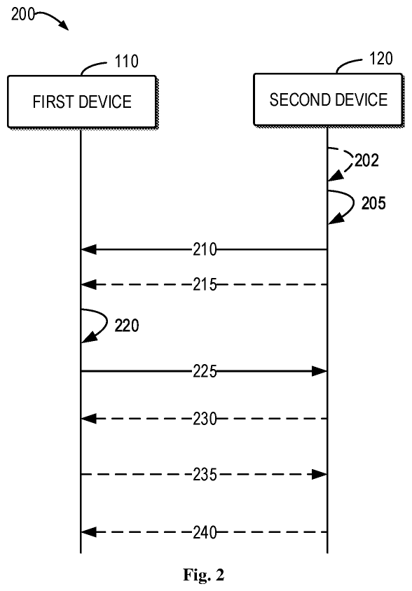

FIG. 2 illustrates a signaling chart showing an example process 200 of RA to a SCell according to some example embodiments of the present disclosure. The process 200 may involve operations and interactions between the first device 110 and the second device 120. For the purpose of discussion, reference will be made to the communication environment shown in FIG. 1.

The second device 120 allocates 205 resources for the first device 110 to perform an RA to the SCell 102 of the first device 110. Such resources are also referred to as “first resources” or “first RA resources” herein. RA resources configured for RA to the PCell 101 are referred to as “second RA resources” or “second resources”. The RA-RNTIs corresponding to the first RA resources are different from RA-RNTIs corresponding to the second RA resources.

In some example embodiments, the first RA resources may be separate RA resources different from common RA resources (which are also referred to as “third resources” or “third RA resources”) in system information broadcast for the SCell 102 by the second device 120. In other words, the first RA resources may be different from the common RA resources configured for the third device 130 to perform RA to the SCell 102 and the third device 130 is able to camp on the SCell 102 or the SCell 102 serves the third device 130 as a PCell. For example, the first RA resources are different from the common RA resources in system information block (SIB) broadcast for the SCell 102 by the second device 120. In this case, the third device 130 may listen to the SIB for the SCell 102, while the first device 110 does not listen to the SIB for the SCell 102. The example embodiments where such separate resources are configured for the first device 110 to perform the RA to the SCell 102 may be referred to as Option 1 for purpose of discussion without any limitation to the protection scope.

In some example embodiments, if Option 1 is adopted, the first RA resources may be RA resources other than normal RA resources used for random access. Since the first RA resources are different from the normal RA resources, the RA-RNTIs corresponding to the first RA resources may not rely on a predefined formula for calculating an RA-RNTI, which is referred to as “RA-RNTI formula”. In some example embodiments, the RA-RNTI formula is as follows: the RA-RNTI associated with the Physical Random Access Channel (PRACH) occasion in which the Random Access Preamble is transmitted is computed as the following equation (1):

RA-RNTI=1+s_id+14×t_id+14×80×f_id+14×80×8×ul_carrier_id (1)
where s_id is the index of the first OFDM symbol of the PRACH occasion (0≤s_id<14), t_id is the index of the first slot of the PRACH occasion in a system frame (0≤t_id<80), where the subcarrier spacing to determine t_id is based on the value of u specified in clause 5.3.2 in TS 38.211 [8], f_id is the index of the PRACH occasion in the frequency domain (0≤f_id<8), and ul_carrier_id is the UL carrier used for Random Access Preamble transmission with 0 for normal UL (NUL) carrier and 1 for Supplementary UL (SUL) carrier.

In such example embodiments, the second device 120 may further configure the RA-RNTIs to be used by the first device 110. Each RA resource of the first RA resources is corresponding to a specific RA-RNTI. For example, each RO is corresponding to or bound to a RA-RNTI configured by the second device 120.

Alternatively, in some example embodiments, if Option 1 is adopted, the first RA resources may be normal RA resources but reserved for the RA to the SCell 102, for example, for CBRA to PUCCH SCell. This means that the reserved normal RA resources are not used in the common configuration for the SCell 102. Accordingly, the second device 120 will not indicate the reserved normal RA resource in the system information (for example, SIB) broadcast for the SCell 102. In this way, the third device 120 which listens to the system information for the SCell 102 will not use the reserved normal RA resources.

In such example embodiments, the RA-RNTIs corresponding to the first RA resources may be calculated based on the RA-RNTI formula and respective offsets. An offset corresponding to an RA resource of the first RA resources may be predefined, for example, in a technical specification or a standard. Alternatively, or in addition, the second device 120 may configure an offset corresponding to each RA resource of the first resources. For example, each RO is corresponding to or bound to an offset configured by the second device 120. As an example, the RA-RNTI associated with the PRACH occasion in which the Random Access Preamble is transmitted is computed as the following equation (2):

RA-RNTI=1+s_id+14×t_id+14×80×f_id+14×80×8×ul_carrier_id+offset (2)
where s_id, t_id, f_id, ul_carrier_id are the same as described with respect to the equation (1).

In some examples, the RA resource provided in the SCell is determined to be another frequency domain occasion on top of the RA resources provided in PCell, i.e., the index of the PRACH occasion of the SCell in frequency domain is the highest index of the PRACH occasion of the PCell in frequency domain plus 1.

In some example embodiments, as alternative to Option 1, RA resources may be partitioned between the PCell 101 and the SCell 102 such that the PCell 101 and the SCell 102 are not configured with RA resources corresponding to same RA-RNTI. These example embodiments may be referred to as Option 2 for purpose of discussion without any limitation to the protection scope.

Continuing with the process 200, the second device 120 transmits 210 to the first device 110 configuration information indicating the first RA resources. The configuration information may be transmitted via dedicated signaling to the first device 110. For example, the second device 120 may transmit the configuration information when the SCell 102 is configured for the first device 110.

The configuration information may further indicate the RA-RNTIs or the offsets corresponding to the first RA resources. Alternatively, the second device 120 may indicate the RA-RNTIs or the offsets to the first device 110 in another dedicated signaling separate from the configuration information. The protection scope of the present disclosure is not limited in this regard.

Based on the received configuration information, the first device 120 selects 220, from the first RA resources, an RA resource to be used. In some example embodiments, the first device 120 may select the RA resource to be used, as in a conventional contention based RA procedure.

In some example embodiments, as shown in FIG. 2, the second device 120 may transmit 215 to the first device 110 mask information indicating a subset of the first RA resources to be used by the first device 110. Accordingly, the first device 110 may select the RA resource from the subset of the first RA resources. The mask information may be transmitted together with the configuration information. Alternatively, the mask information may be transmitted via a dedicated signaling after the configuration information.

The mask information may be transmitted in a Radio Resource Control (RRC) signaling or a Medium Access Control (MAC) Control Element (CE). In the scenario of PUCCH SCell activation, the mask information may be included in the SCell activation command from the second device 120 to the first device 110. As an example, the mask information may be implemented as a random access channel (RACH) mask index. By using the mask information, the second device 120 (for example, the gNB) can flexibly use the RACH configuration for multiple devices (for examples, UEs) performing RA to the SCell 102.

The first device 110 transmits 225, to the second device 120 via the SCell 102, a random access request by using the selected RA resource. For example, the selected RA resource may comprise a RO and one or more corresponding random access preambles. The first device 110 may transmit a corresponding random access preamble over the RO via the SCell 102.

In the example embodiments where Option 1 is adopted, upon receiving the random access request by using the RA resource of the first RA resource, the second device 120 may know that the request received by using the RA resource is used for TA of the SCell 102. This is because the first RA resources are different from the common resources configured for the third device 130. Accordingly, the second device 102 may determine an RA-RNTI corresponding to the used RA resource. For example, the second device 120 may determine the RA-RNTI which is configured to the used RA resources. Alternatively, the second device 120 may calculate the RA-RNTI based on the RA-RNTI formula and the offset corresponding to the used RA resource.

Accordingly, the second device 120 may transmit 230, to the first device 110 via the PCell 101, a RAR on a control channel addressed to the determined RA-RNTI. For example, if the first device 110 is a terminal device and the second device 120 is a network device, the second device 120 may transmit, to the first device 110 via the PCell 101, the RAR scheduled by PDCCH addressed to the configured or calculated RA-RNTI.

On the side of the first device 110, since the first device 110 knows the used RA resource as well as the corresponding RA-RNTI, the first device 110 determines that the received RAR addressed to the corresponding RA-RNTI is s response for the RA to the SCell 102.

Alternatively, in example embodiments where Option 2 is adopted, double RARs might still need to be transmitted via the PCell 101 and SCell 102, respectively, upon reception of the random access request. This is because the second device 120 may not be able to distinguish whether the first device 110 or the third device 130 transmits the request. The RAR may be transmitted on a control channel addressed to an RA-RNTI corresponding to the used RA resource. The RA-RNTI may be calculated based on the RA-RNTI formula.

In some example embodiments, the second device 120 may transmit 230 a RAR via the PCell 101 when the second device 120 is expecting CBRA from the SCell 102. For example, if the second device 120 has transmitted to the first device 110 a PUCCH SCell activation command to activate the SCell 102, the second device 120 may transmit the RAR via the PCell 101.

In some example embodiments, the second device 120 may transmit a RAR via the SCell 102 if another device is able to camp on the SCell 102 or is camping on the SCell 102 or the SCell 102 serves another device as a PCell. For example, if the third device 130 camps on the SCell 102 or the SCell 102 acts as a PCell for the third device 130, the third device 130 may monitor the CSS of the SCell 102.

On the side of the first device 110, since the first device 110 is attempting RA to the SCell 102, the first device 110 monitors RAR from the PCell 101. Thus, the first device 110 is able to distinguish whether the RAR is for the PCell 101 or the SCell 102 from the corresponding RA-RNTI.

Continuing with the process 200, in response to receiving the RAR from the second device 120, the first device 110 may transmit 235, to the second device 110, a message that is MSG3. MSG3 may be transmitted via the PCell 101 or the SCell 102.

In some example embodiments, the second device 120 may configure or indicate the first device 110 to transmit the MSG3 via the PCell 101 or via the SCell 102. For example, the RAR from the second device 120 may include an indication or configuration indicating whether the MSG3 is to be transmitted via the PCell 101 or the SCell 102. The first device 110 may select a cell from the PCell 101 and the SCell 102 based on the RAR and may transmit the MSG3 to the second device 120 via the selected cell.

In some example embodiments, the second device 120 may transmit 240, to the first device 110 via the SCell 102, a grant for transmission from the first device 110 to the second device 120. The grant may serve as a contention resolution for the RA procedure to the SCell 102. For example, if the first device 110 is a terminal device and the second device 120 is a network device, the second device 120 may transmit a DL assignment to the first device 110 via the SCell 102 as the contention resolution. In some examples, the second device 120 may transmit data in the DL transmission scheduled by the DL assignment to the first device 110 via the SCell 102.

Some example embodiments where Option 1 or Option 2 is adopted are described with reference to FIG. 2. By configuring such first RA resources, the RA to SCell is enabled to solve the issue of the network not knowing beam information when activating an unknown PUCCH SCell without valid TA.

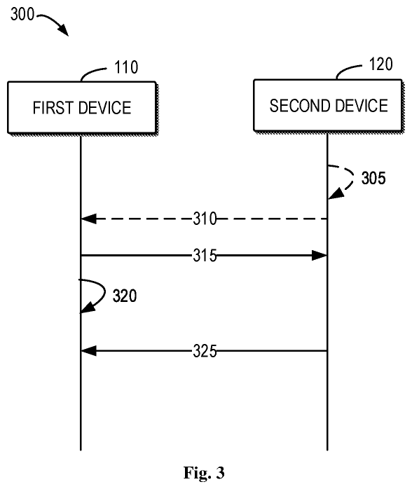

In some example embodiments, the first device 110 may monitor the CSS of the SCell 102, which may be referred to as “Option 3”. Reference is now made to FIG. 3. FIG. 3 illustrates a signaling chart showing another example process 300 of RA to a SCell according to some example embodiments of the present disclosure. The process 300 may involve operations and interactions between the first device 110 and the second device 120. For the purpose of discussion, reference will be made to the communication environment shown in FIG. 1.

The first device 110 transmits 315 a random access request to the second device 120 via the SCell 102. The random access request including a random access preamble is transmitted by using a RA resource. The first device 110 monitors 320 the CSS of the SCell 102 for a control channel of the SCell 102. For example, if the first device 110 is a terminal device and the second device 120 is a network device, the first device 110 may monitor the CSS of the SCell 102 for PDCCH of the SCell 102. In some example embodiments, the time period to monitor the CSS of SCell 102 may be considered. For example, in the scenario of PUCCH SCell activation, the time period may be related to the PUCCH SCell activation delay.

Upon receiving the random access request, the second device 120 transmits 325 a RAR to the first device 110 via the SCell 102. Since the first device 110 is monitoring the CSS of the SCell 102, the second device 120 can receive the RAR from the second device 120 via the SCell 102.

In some example embodiments, it may be configurable which option to adopt depends on whether the SCell 102 is as a capable cell or acting as PCell for other devices (for example, other UEs). Option 3 can be adopted, if the SCell 102 acts as a PCell for the third device 130 or the third device 130 is able to camp on the SCell 102.

As shown in FIG. 3, the second device 120 may determine 305 whether the SCell 102 acts as a PCell for the third device 130 or whether the third device 130 is able to camp on the SCell 102. If the SCell 102 acts as a PCell for the third device 130 or the third device 130 is able to camp on the SCell 102 or is camping on the SCell 102, the second device 120 may transmit 310, to the first device 110, an indication for monitoring the CSS of the SCell 102. That is, the second device 120 indicates to the first device 110 to monitor the CSS of the SCell 102.

In such example embodiments, since the SCell 102 acts as a PCell for the third device 130 or the third device 130 is able to camp on the SCell 102 or is camping on the SCell 102, the SCell 102 is already configured with a CSS. In this way, no extra CSS would be introduced for the SCell 102.

Reference is now made back to FIG. 2. Option 1 or 2 can be adopted, if the SCell 102 does not acts as a PCell for any other device and no other device is able to camp on the SCell 102. As shown in FIG. 2, the second device 120 may determine 202 whether the SCell 102 acts as a PCell for any other device or whether any other device is able to camp on the SCell 102. If the SCell 102 does not acts as a PCell for any other device and no other device is able to camp on the SCell 102, the second device 120 may allocate 205 the first RA resources. In addition, the second device 120 may transmit to the first device 110 an indication or a configuration to indicate to the first device 110 to perform the RA to the SCell 102 based on the first RA resources.

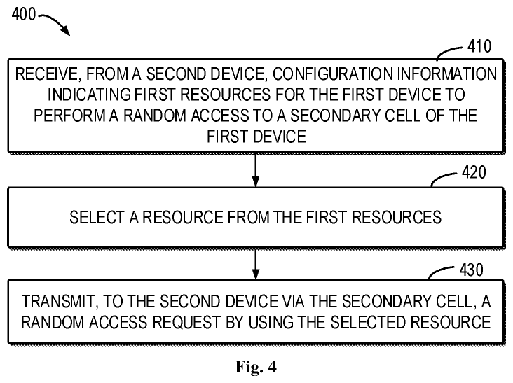

FIG. 4 illustrates a flowchart of a method 400 implemented at the first device 110 according to some example embodiments of the present disclosure. For the purpose of discussion, the method 400 will be described with reference to FIG. 1.

At block 410, the first device 110 receives configuration information from a second device 120. The configuration information indicates first resources for the first device 110 to perform a random access to a secondary cell of the first device 110. The radio network temporary identifiers corresponding to the first resources are different from radio network temporary identifiers corresponding to second resources configured for a random access to a primary cell of the first device 110.

At block 420, the first device 110 selects a resource from the first resources. In some example embodiments, the first device 110 may receive, from the second device 120, mask information indicating a subset of the first resources; and select, from the subset of the first resources, the resource used to transmit the random access request.

At block 430, the first device 110 transmits to the second device 120 via the secondary cell, a random access request by using the selected resource.

In some example embodiments, a resource of the first resources is corresponding to: a radio network temporary identifier configured by the second device 120, a radio network temporary identifier calculated based on a predefined formula, or a radio network temporary identifier calculated based on a predefined formula and an offset.

In some example embodiments, the first device 110 may determine a radio network temporary identifier corresponding to the selected resource; and receive from the second device 120 via the primary cell a random access response on a control channel addressed to the determined radio network temporary identifier.

In some example embodiments, the first device 110 may select from the secondary cell and the primary cell, a cell indicated in the random access response; and transmit a message to the second device 120 via the selected cell. For example, the message may be Msg3 in a random access procedure.

In some example embodiments, the first device 110 may receive from the second device 120 via the secondary cell a grant for transmission from the first device 110 to the second device 120 as a contention resolution for the random access to the secondary cell.

In some example embodiments, the first resources are different from third resources indicated in system information broadcast for the secondary cell by the second device 120 and configured for a further random access to the secondary cell.

FIG. 5 illustrates a flowchart of a method 500 implemented at the second device 120 according to some example embodiments of the present disclosure. For the purpose of discussion, the method 500 will be described with reference to FIG. 1.

At block 510, the second device 120 allocates first resources for the first device 110 to perform a random access to a secondary cell of the first device 110. Radio network temporary identifiers corresponding to the first resources are different from radio network temporary identifiers corresponding to second resources configured for a random access to a primary cell of the first device 110.

In some example embodiments, the first device 110 may determine whether the secondary cell acts as a primary cell for a third device 130 different from the first device 110 or the third device 130 is able to camp on the secondary cell; and in accordance with a determination that the secondary cell does not act as a primary cell for the third device 130 and the third device 130 is unable to camp on the secondary cell, the first device 110 may allocate the first resources.

At block 520, the second device 120 transmits to the first device 110 configuration information indicating the first resources. At block 530, the second device 120 receives via the secondary cell, a random access request by using a resource from the first resources.

In some example embodiments, a resource of the first resources is corresponding to: a radio network temporary identifier configured by the second device, a radio network temporary identifier calculated based on a predefined formula, or a radio network temporary identifier calculated based on a predefined formula and an offset.

In some example embodiments, the second device 120 may determine a radio network temporary identifier corresponding to the used resource; and transmit to the first device 110 via the primary cell, a random access response on a control channel addressed to the determined radio network temporary identifier.

In some example embodiments, the random access response may indicate a cell of the secondary cell and the primary cell. The second device 120 may receive a message from the first device 110 via the indicated cell. For example, the message may be Msg3 in a random access procedure.

In some example embodiments, the second device 120 may transmit to the first device 110 via the secondary cell, a grant for transmission from the first device 110 to the second device 120 as a contention resolution for the random access to the secondary cell.

In some example embodiments, the second device 120 may transmit to the first device 110 mask information indicating a subset of the first resources, wherein the used resource is selected from the subset of the first resources by the first device 110.

In some example embodiments, the first resources are different from third resources indicated in system information broadcast for the secondary cell by the second device 120 and configured for a further random access to the secondary cell.

In some example embodiments, a first apparatus capable of performing method 400 (for example, the first device 110) comprises: means for receiving, from a second apparatus, configuration information indicating first resources for the first apparatus to perform a random access to a secondary cell of the first apparatus, wherein radio network temporary identifiers corresponding to the first resources are different from radio network temporary identifiers corresponding to second resources configured for a random access to a primary cell of the first apparatus; means for selecting a resource from the first resources; and means for transmitting, to the second apparatus via the secondary cell, a random access request by using the selected resource.

In some example embodiments, a resource of the first resources is corresponding to: a radio network temporary identifier configured by the second apparatus, a radio network temporary identifier calculated based on a predefined formula, or a radio network temporary identifier calculated based on a predefined formula and an offset.

In some example embodiments, the first apparatus further comprises means for determining a radio network temporary identifier corresponding to the selected resource; and means for receiving, from the second apparatus via the primary cell, a random access response on a control channel addressed to the determined radio network temporary identifier.

In some example embodiments, the first apparatus further comprises means for selecting, from the secondary cell and the primary cell, a cell indicated in the random access response; and means for transmitting a message to the second apparatus via the selected cell.

In some example embodiments, the first apparatus further comprises means for receiving, from the second apparatus via the secondary cell, a grant for transmission from the first apparatus to the second apparatus as a contention resolution for the random access to the secondary cell.

In some example embodiments, the means for selecting the resource from the first resources comprises: means for receiving, from the second apparatus, mask information indicating a subset of the first resources; and means for selecting, from the subset of the first resources, the resource used to transmit the random access request.

In some example embodiments, the first resources are different from third resources indicated in system information broadcast for the secondary cell by the second apparatus and configured for a further random access to the secondary cell.

In some example embodiments, a second apparatus capable of performing method 500 (for example, the second device 120) comprises: means for allocating first resources for a first apparatus to perform a random access to a secondary cell of the first apparatus, wherein radio network temporary identifiers corresponding to the first resources are different from radio network temporary identifiers corresponding to second resources configured for a random access to a primary cell of the first apparatus; means for transmitting, to the first apparatus, configuration information indicating the first resources; and means for receiving, via the secondary cell, a random access request by using a resource from the first resources.

In some example embodiments, a resource of the first resources is corresponding to: a radio network temporary identifier configured by the second apparatus, a radio network temporary identifier calculated based on a predefined formula, or a radio network temporary identifier calculated based on a predefined formula and an offset.

In some example embodiments, the second apparatus further comprises means for determining a radio network temporary identifier corresponding to the used resource; and means for transmitting, to the first apparatus via the primary cell, a random access response on a control channel addressed to the determined radio network temporary identifier.

In some example embodiments, the random access response may indicate a cell of the secondary cell and the primary cell. The second apparatus further comprises means for receiving a message from the first apparatus via the indicated cell.

In some example embodiments, the second apparatus further comprises means for transmitting, to the first apparatus via the secondary cell, a grant for transmission from the first apparatus to the second apparatus as a contention resolution for the random access to the secondary cell.

In some example embodiments, the second apparatus further comprises means for transmitting, to the first apparatus, mask information indicating a subset of the first resources, wherein the used resource is selected from the subset of the first resources by the first apparatus.

In some example embodiments, the first resources are different from third resources indicated in system information broadcast for the secondary cell by the second apparatus and configured for a further random access to the secondary cell.

In some example embodiments, the means for allocating the first resources comprises: means for determining whether the secondary cell acts as a primary cell for a third apparatus different from the first apparatus or the third apparatus is able to camp on the secondary cell; and in accordance with a determination that the secondary cell does not act as a primary cell for the third apparatus and the third apparatus is unable to camp on the secondary cell, means for allocating the first resources.

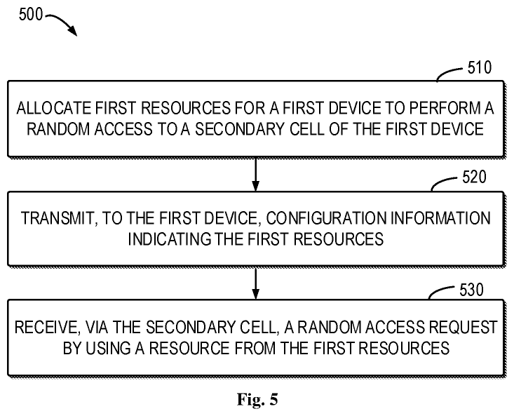

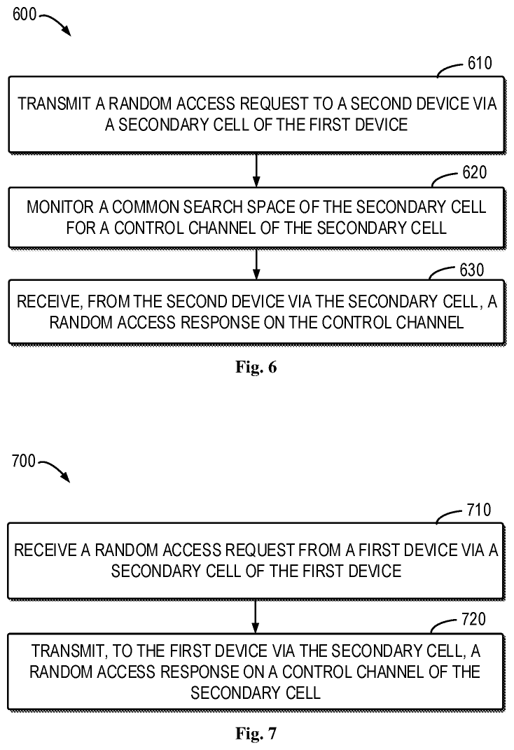

FIG. 6 illustrates a flowchart of a method 600 implemented at the first device 110 according to some example embodiments of the present disclosure. For the purpose of discussion, the method 600 will be described with reference to FIG. 1.

At block 610, the first device 110 transmits a random access request to a second device 120 via a secondary cell of the first device 110. At block 620, the first device 110 monitors a common search space of the secondary cell for a control channel of the secondary cell. At block 630, the first device 110 receives, from the second device 120 via the secondary cell, a random access response on the control channel.

FIG. 7 illustrates a flowchart of a method 700 implemented at the second device 120 according to some example embodiments of the present disclosure. For the purpose of discussion, the method 700 will be described with reference to FIG. 1.

At block 710, the second device 120 receives a random access request from a first device 110 via a secondary cell of the first device 110. At block 720, the second device 120 transmits, to the first device 110 via the secondary cell, a random access response on a control channel of the secondary cell.

In some example embodiments, the second device 120 may determine whether the secondary cell acts as a primary cell for a third device 130 different from the first device 110 or the third device 130 is able to camp on the secondary cell; and in accordance with a determination that the secondary cell act as the primary cell for the third device or the third device is able to camp on the secondary cell, transmit to the first device 110 an indication for monitoring a common search space of the secondary cell.

In some example embodiments, a first apparatus capable of performing method 600 (for example, the first device 110) comprises: means for transmitting a random access request to a second device via a secondary cell of the first device; means for monitoring a common search space of the secondary cell for a control channel of the secondary cell; and means for receiving, from the second device via the secondary cell, a random access response on the control channel.

In some example embodiments, a second apparatus capable of performing method 700 (for example, the second device 120) comprises: means for receiving a random access request from a first device via a secondary cell of the first device; and means for transmitting, to the first device via the secondary cell, a random access response on a control channel of the secondary cell.

In some example embodiments, the second apparatus further comprises means for determining whether the secondary cell acts as a primary cell for a third device different from the first device or the third device is able to camp on the secondary cell; and means for in accordance with a determination that the secondary cell act as the primary cell for the third device or the third device is able to camp on the secondary cell, transmitting to the first device an indication for monitoring a common search space of the secondary cell.

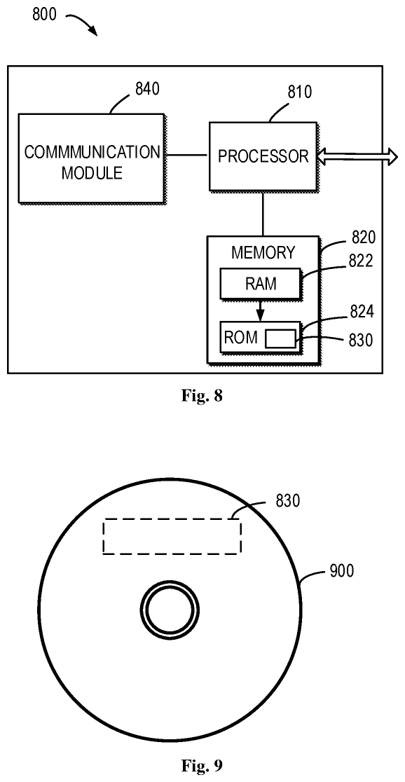

FIG. 8 is a simplified block diagram of a device 800 that is suitable for implementing example embodiments of the present disclosure. The device 800 may be provided to implement a communication device, for example, the first device 110 or the second device 120 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the memory, e.g., ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIGS. 4 to 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 which may be in form of CD, DVD or other optical storage disk. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 4 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-33. (canceled)

34. A first apparatus comprising:
at least one processor; and
at least one memory including computer program codes;
the at least one memory and the computer program codes are configured to, with the at least one processor, cause the first apparatus at least to:
receive, from a second apparatus, configuration information indicating first resources for the first apparatus to perform a random access to a secondary cell of the first apparatus, wherein radio network temporary identifiers corresponding to the first resources are different from radio network temporary identifiers corresponding to second resources configured for a random access to a primary cell of the first apparatus;
select a resource from the first resources; and
transmit, to the second apparatus via the secondary cell, a random access request by using the selected resource.

35. The first apparatus of claim 34, wherein a resource of the first resources is corresponding to:
a radio network temporary identifier configured by the second apparatus,
a radio network temporary identifier calculated based on a predefined formula, or
a radio network temporary identifier calculated based on a predefined formula and an offset.

36. The first apparatus of claim 35, wherein the at least one memory and the computer program codes are configured to, with the at least one processor, further cause the first apparatus to:
determine a radio network temporary identifier corresponding to the selected resource; and
receive, from the second apparatus via the primary cell, a random access response on a control channel addressed to the determined radio network temporary identifier.

37. The first apparatus of claim 36, wherein the at least one memory and the computer program codes are configured to, with the at least one processor, further cause the first apparatus to:
select, from the secondary cell and the primary cell, a cell indicated in the random access response; and
transmit a message to the second apparatus via the selected cell.

38. The first apparatus of claim 34, wherein the at least one memory and the computer program codes are configured to, with the at least one processor, further cause the first apparatus to:
receive, from the second apparatus via the secondary cell, a grant for transmission from the first apparatus to the second apparatus as a contention resolution for the random access to the secondary cell.

39. The first apparatus of claim 34, wherein the at least one memory and the computer program codes are configured to, with the at least one processor, cause the first apparatus to select the resource from the first resources by:
receiving, from the second apparatus, mask information indicating a subset of the first resources; and
selecting, from the subset of the first resources, the resource used to transmit the random access request.

40. The first apparatus of claim 34, wherein the first resources are different from third resources indicated in system information broadcast for the secondary cell by the second apparatus and configured for a further random access to the secondary cell.

41. A second apparatus comprising:
at least one processor; and
at least one memory including computer program codes;
the at least one memory and the computer program codes are configured to, with the at least one processor, cause the second apparatus at least to:
allocate first resources for a first apparatus to perform a random access to a secondary cell of the first apparatus, wherein radio network temporary identifiers corresponding to the first resources are different from radio network temporary identifiers corresponding to second resources configured for a random access to a primary cell of the first apparatus;
transmit, to the first apparatus, configuration information indicating the first resources; and
receive, via the secondary cell, a random access request by using a resource from the first resources.

42. The second apparatus of claim 41, wherein a resource of the first resources is corresponding to:
a radio network temporary identifier configured by the second apparatus,
a radio network temporary identifier calculated based on a predefined formula, or
a radio network temporary identifier calculated based on a predefined formula and an offset.

43. The second apparatus of claim 42, wherein the at least one memory and the computer program codes are configured to, with the at least one processor, further cause the second apparatus to:
determine a radio network temporary identifier corresponding to the used resource; and
transmit, to the first apparatus via the primary cell, a random access response on a control channel addressed to the determined radio network temporary identifier.

44. The second apparatus of claim 43, wherein the random access response indicates a cell of the secondary cell and the primary cell, and the at least one memory and the computer program codes are configured to, with the at least one processor, further cause the second apparatus to:
receive a message from the first apparatus via the indicated cell.

45. The second apparatus of claim 41, wherein the at least one memory and the computer program codes are configured to, with the at least one processor, further cause the second apparatus to:
transmit, to the first apparatus via the secondary cell, a grant for transmission from the first apparatus to the second apparatus as a contention resolution for the random access to the secondary cell.

46. The second apparatus of claim 41, wherein the at least one memory and the computer program codes are configured to, with the at least one processor, further cause the second apparatus to:
transmit, to the first apparatus, mask information indicating a subset of the first resources, wherein the used resource is selected from the subset of the first resources by the first apparatus.

47. The second apparatus of claim 41, wherein the first resources are different from third resources indicated in system information broadcast for the secondary cell by the second apparatus and configured for a further random access to the secondary cell.

48. The second apparatus of claim 41, wherein the at least one memory and the computer program codes are configured to, with the at least one processor, cause the second apparatus to allocate the first resources by:
determining whether the secondary cell acts as a primary cell for a third apparatus different from the first apparatus or whether the third apparatus is able to camp on the secondary cell; and
in accordance with a determination that the secondary cell does not act as a primary cell for the third apparatus and that the third apparatus is unable to camp on the secondary cell, allocating the first resources.

49. A method comprising, by a first apparatus:
receiving, from a second apparatus, configuration information indicating first resources for the first apparatus to perform a random access to a secondary cell of the first apparatus, wherein radio network temporary identifiers corresponding to the first resources are different from radio network temporary identifiers corresponding to second resources configured for a random access to a primary cell of the first apparatus;
selecting a resource from the first resources; and
transmitting, to the second apparatus via the secondary cell, a random access request by using the selected resource.

50. The method of claim 49, wherein a resource of the first resources is corresponding to:
a radio network temporary identifier configured by the second apparatus,
a radio network temporary identifier calculated based on a predefined formula, or
a radio network temporary identifier calculated based on a predefined formula and an offset.

51. The method of claim 50, further comprising, by the first apparatus:
determining a radio network temporary identifier corresponding to the selected resource; and
receiving, from the second apparatus via the primary cell, a random access response on a control channel addressed to the determined radio network temporary identifier.

52. The method of claim 51, further comprising, by the first apparatus:
selecting, from the secondary cell and the primary cell, a cell indicated in the random access response; and
transmitting a message to the second apparatus via the selected cell.

53. The method of claim 49, further comprising, by the first apparatus:
receiving, from the second apparatus via the secondary cell, a grant for transmission from the first apparatus to the second apparatus as a contention resolution for the random access to the secondary cell.
